(19) United States
(12) Patent Application Publication
(10) Pub. No.: US 2009/0094625 A1
(43) Pub. Date: Apr. 9, 2009

(54) DATA REPRODUCTION APPARATUS LOADABLE WITH CARD-SHAPED STORAGE MEDIUM

(75) Inventor: Takeshi Yamamoto, Musashimurayama-shi (JP)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: TEAC CORPORATION, Tokyo (JP)

(21) Appl. No.: 12/238,332

(22) Filed: Sep. 25, 2008

(30) Foreign Application Priority Data
Oct. 3, 2007 (JP) 2007-259403

(51) Int. Cl. G11B 17/04

(52) U.S. Cl. 720/618; G9B/17.013

(57) ABSTRACT

A data reproduction apparatus for reproducing audio data includes an insertion slot, formed to open horizontally, for loading a card-shaped storage medium. An ejector ejects the card-shaped storage medium through the insertion slot when operated externally. A cover is positioned outside the insertion slot, rotatable between open and closed positions, having a receiving surface, for extending outwards from a lower edge of the insertion slot when in the open position, to support a lower surface of the card-shaped storage medium moving inwards or outwards through the insertion slot on the receiving surface, and for covering the insertion slot when in the closed position, to close the insertion slot. Also, the cover includes first and second side guide projections, positioned on the receiving surface, for contacting lateral edges of the card-shaped storage medium, to guide during insertion and ejection.

### BACKGROUND OF THE INVENTION

1. Field of the Invention

The present invention relates to a data reproduction apparatus loadable with a card-shaped storage medium. More particularly, the present invention relates to a data reproduction apparatus loadable with a card-shaped storage medium, in which the storage medium can be inserted and ejected easily and safely without accidental drop.

2. Description Related to the Prior Art

A card-shaped storage medium, such as a memory card known in the field of storage, has been considerably developed recently so that its capacity has become still greater. A data reproduction apparatus for use with the card-shaped storage medium is becoming utilized as new generation storage in place of CD, DVD or other conventional storage media.

In the data reproduction apparatus, an insertion slot receives insertion of the card-shaped storage medium toward a body casing. The card-shaped storage medium or memory card can be read for playback by connection with connection terminals disposed inside the body casing. A port cover of the data reproduction apparatus is disposed to close the insertion slot in an openable manner, and protects the body casing from entry of fine dust or the like. Shock or vibration is likely to occur on the data reproduction apparatus according to the environment of the use. Failure in the data reading may occur when the card-shaped storage medium is disconnected by considerable vibration. A holding mechanism for the card-shaped storage medium is disclosed in JP-A 11-095869, in which a stopper for the card-shaped storage medium is disposed on the port cover for keeping firm connection in the body casing.

However, the card-shaped storage medium or memory card is difficult to insert in the insertion slot according to JP-A 11-095869, because the card-shaped storage medium has a small size and also the insertion slot has a corresponding small size. The card-shaped storage medium is likely to drop when failure in the insertion occurs at the insertion slot.

To remove the card-shaped storage medium or memory card, an operation of ejection is carried out. If the stroke of the ejection is small, the card-shaped storage medium is difficult to remove. It is conceivable to predetermine the stroke of the ejection great in order to facilitate the removal. However, a problem arises in that the great value of the stroke of the ejection is likely to cause a drop of the card-shaped storage medium from the body casing in the ejecting operation.

### SUMMARY OF THE INVENTION

In view of the foregoing problems, an object of the present invention is to provide a data reproduction apparatus loadable with a card-shaped storage medium, in which the storage medium can be inserted and ejected easily and safely without accidental drop.

In order to achieve the above and other objects and advantages of this invention, a data reproduction apparatus for reproducing data in a card-shaped storage medium includes an insertion slot, formed to open substantially horizontally, for insertion of the card-shaped storage medium to load. An ejector ejects the card-shaped storage medium through the insertion slot. A cover is positioned outside the insertion slot, rotatable between open and closed positions, has a receiving surface, for extending outwards from a lower edge of the insertion slot when in the open position, to guide a lower surface of the card-shaped storage medium moving inwards or outwards through the insertion slot on the receiving surface, and for covering and closing the insertion slot when in the closed position.

Furthermore, a holder chamber has the insertion slot, for loading the card-shaped storage medium therein. A case contains the holder chamber with the insertion slot positioned to appear externally when the cover is in the open position. A rotational support mechanism supports the cover in a rotatable manner.

The cover includes a guide plate having the receiving surface on an inner side. An outer panel is secured to an outer side of the guide plate.

The guide plate is formed from resin, and the outer panel is formed from metal.

The cover includes first and second side guide projections, positioned on the receiving surface, for contacting lateral edges of the card-shaped storage medium to guide.

Furthermore, an inclined end portion is formed at an outer end of at least one of the first and second side guide projections, inclined to spread with reference to a sliding direction of the card-shaped storage medium, for guiding a lateral edge of the card-shaped storage medium in insertion.

The rotational support mechanism includes a pivot shaft disposed on the case to extend substantially horizontally. A pivot hole is formed through a lower portion of the cover, for receiving insertion of the pivot shaft.

Furthermore, a first stopper portion positions the cover in the open position. A second stopper portion positions the cover in the closed position. A biasing mechanism biases the cover toward the first stopper portion upon rotation toward the open position, and biases the cover toward the second stopper portion upon rotation toward the closed position.

The biasing mechanism includes a spring plate. Furthermore, a regulating arm is disposed to project from the cover, positioned inside the case, and pressed by the spring plate in the open and closed positions.

The spring plate includes a base portion, a middle portion and an end portion. The base portion is secured to the case. The middle portion extends from the base portion, and presses the regulating arm in a first rotational direction when the cover is in the open position. The end portion extends from the middle portion, and presses the regulating arm in a second rotational direction when the cover is in the closed position.

The cover further includes a tilted portion, tilted downwards from the receiving surface toward the insertion slot, for guiding an edge between a proximal end surface of the card-shaped storage medium and the lower surface in ejection.

Also, a data reproduction apparatus for reproducing data in a card-shaped storage medium is provided. An insertion slot is formed to open substantially horizontally, for insertion of said card-shaped storage medium to load. A built-in connector electrically connects with said card-shaped storage medium loaded through said insertion slot. A cover is positioned outside said insertion slot, rotatable between open and closed positions, having a receiving surface, for extending outwards from a lower edge of said insertion slot when in said open position, to support a lower surface of said card-shaped storage medium moving inwards or outwards through said insertion slot on said receiving surface, and for covering and closing said insertion slot when in said closed position.

Consequently, the card-shaped storage medium can be inserted and ejected easily and safely without accidental drop, because the cover can operate to support the card-shaped storage medium during insertion and ejection.

### BRIEF DESCRIPTION OF THE DRAWINGS

The above objects and advantages of the present invention will become more apparent from the following detailed description when read in connection with the accompanying drawings, in which:

FIG. 1 is a perspective view illustrating a data reproduction apparatus;

FIG. 2 is a perspective view illustrating a cover on a front panel;

FIG. 3 is a vertical section illustrating a body casing with the front panel and the cover;

FIG. 4 is a vertical section illustrating the front panel on the cover in an open position;

FIG. 5 is a perspective view illustrating the front panel on the cover in an open position;

FIG. 6 is a perspective view illustrating the same as FIG. 5 but in a state during ejection.

### DETAILED DESCRIPTION OF THE PREFERRED EMBODIMENT(S) OF THE PRESENT INVENTION

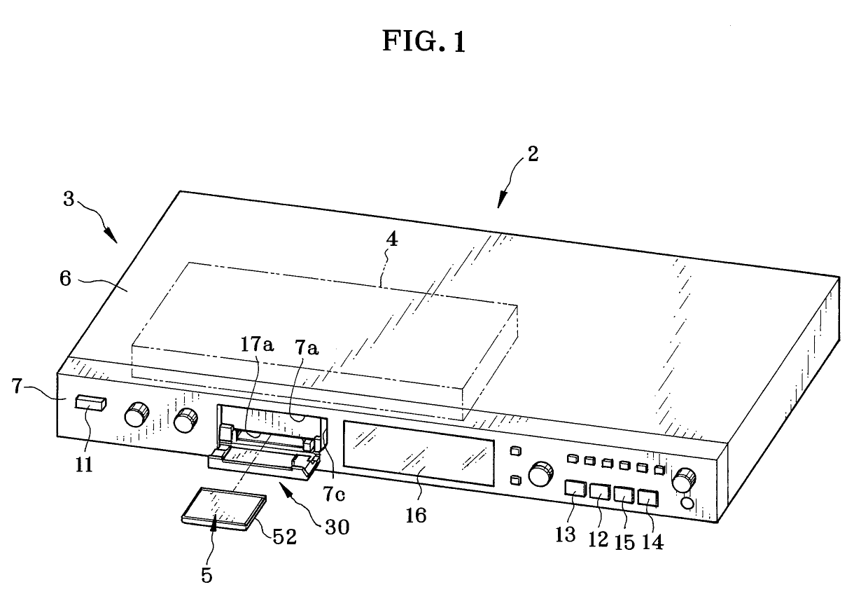

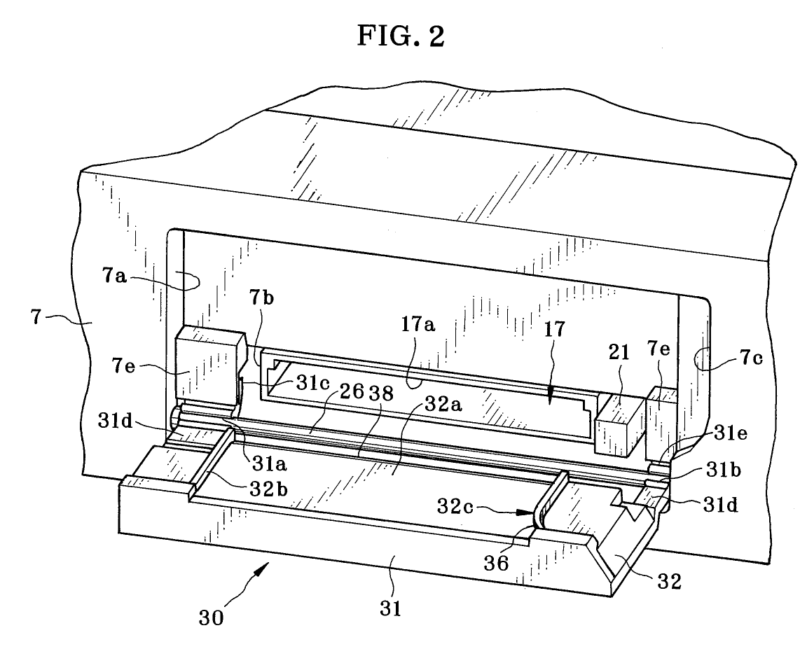

In FIGS. 1 and 2, a data reproduction apparatus or memory recorder 2, namely media player or card reader includes a case 3 and a reader/writer 4 disposed in the case 3. A card-shaped storage medium 5 such as a Compact Flash memory card (trade name) is loadable in the reader/writer 4, which records audio data to the card-shaped storage medium 5, and/or plays back audio data from the card-shaped storage medium 5. The case 3 includes a body casing 6 and a front panel 7. The body casing 6 contains the reader/writer 4. The front panel 7 is secured to a front side of the body casing 6. On the front panel 7 are disposed various buttons for operation and a display panel 16, the buttons including a power button 11, a play button 12, a stop button 13, a record button 14, and a pause button 15.

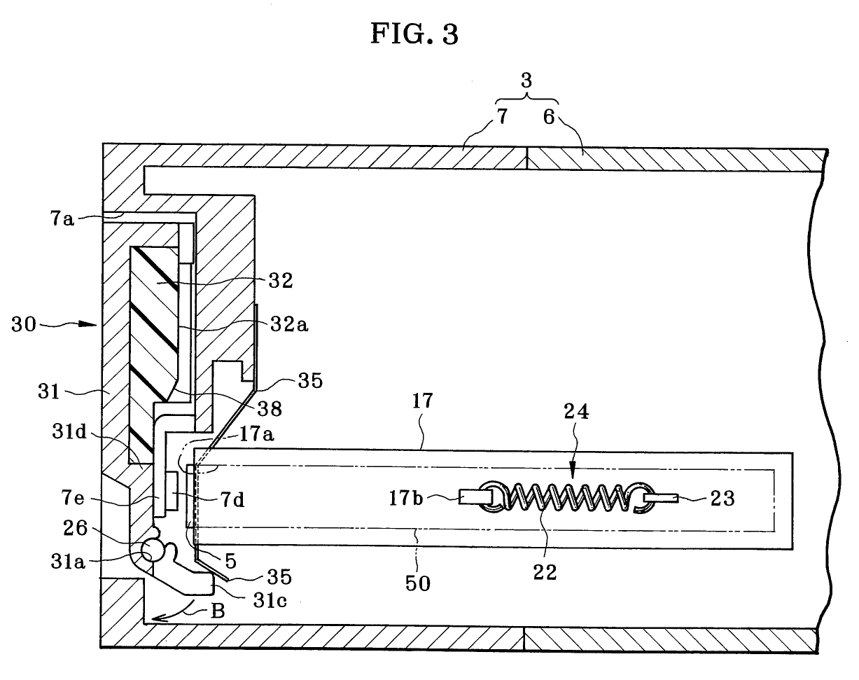

In FIGS. 2 and 3, a recess 7a is formed in the front panel 7. A front opening 7b is formed through the front panel 7 inside the recess 7a. A holder chamber 17 is formed inside the case 3 for loading the card-shaped storage medium 5 therein. An insertion slot 17a is an open front end of the holder chamber 17, and extends horizontally for insertion of the card-shaped storage medium 5. The holder chamber 17 is accessible through the front opening 7b, where the insertion slot 17a appears externally. The card-shaped storage medium 5 is inserted through the insertion slot 17a into the holder chamber 17, and pressed in to the play position of FIG. 3. Then the card-shaped storage medium 5 is electrically connected with the reader/writer 4 for playback and recording of data.

An eject button 21 is disposed in the recess 7a for ejecting the card-shaped storage medium 5 contained in the holder chamber 17. An ejection spring 22 and an ejector 24 are positioned inside the case 3. A latch arm 23 or slide lever is included in the ejector 24. A first end of the ejection spring 22 or tension coil spring is secured to a spring hook 17b for connection with the holder chamber 17. A second end of the ejection spring 22 is secured to the latch arm 23.

The latch arm 23 is slidable back and forth, namely to the right and left in FIG. 3, and is partially contained in the holder chamber 17. When the card-shaped storage medium 5 is pushed in toward the play position, the card-shaped storage medium 5 contacts and moves the latch arm 23 in the inward direction. When the card-shaped storage medium 5 is set in the play position, the latch arm 23 is locked in a state of charging the ejection spring 22. When the eject button 21 is depressed, the latch arm 23 is unlocked, and caused by the bias of the ejection spring 22 to slide in the outward direction by a predetermined stroke. In response to this, the card-shaped storage medium 5 protrudes from the insertion slot 17a by sliding at a predetermined stroke.

A pivot shaft 26 is associated with the front panel 7 and extends horizontally below the insertion slot 17a. A cover 30 or door is disposed to open and close the insertion slot 17a, and is kept rotatable by the pivot shaft 26. The cover 30 is in an open position of FIG. 2 to open the insertion slot 17a. The cover 30, when rotated about the pivot shaft 26, is set in a closed position where the insertion slot 17a is covered by the cover 30 contained in the recess 7a. An access opening 7c is formed in a front portion of the front panel 7, and adapted to insertion of a user's finger. He or she can rotationally move the cover 30 to the open position manually through the access opening 7c. A cover open sensor of a pushbutton type is disposed inside the front panel 7 and generates a signal of an open status of the cover 30. When the cover 30 opens, information of the open status is displayed on the display panel 16 in response to the signal from the cover open sensor.

The cover 30 includes an outer panel 31 and a guide plate 32. The outer panel 31 is formed from aluminum. The guide plate 32 is formed from ABS resin (acrylonitrile butadiene styrene resin). The outer panel 31 includes a left pivot hole 31a in a fork portion, a right pivot hole 31b in a fork portion, a regulating arm 31c for the open position, a regulating arm 31d for the closed position, and a sensor pressing portion 31e. The pivot holes 31a and 31b receive insertion of the pivot shaft 26. The regulating arm 31c contacts the front panel 7 when the outer panel 31 rotates to the open position. The regulating arm 31d contacts the front panel 7 when the outer panel 31 rotates to the closed position. The sensor pressing portion 31e depresses the cover open sensor when the outer panel 31 is in the open position. When the pivot shaft 26 is inserted in the pivot holes 31a and 31b, the outer panel 31 is rotatable about the pivot shaft 26. Note that any suitable material can be used for the guide plate 32, for example, resins other than ABS resin, and substances other than resins. The guide plate 32 can have smaller friction of the surface than the outer panel 31.

A receiving surface 32a is an inner surface of the guide plate 32 for supporting a lower surface 50 of the card-shaped storage medium 5 during its insertion and ejection. When the cover 30 is set rotationally in the open position, the receiving surface 32a is kept flush with a lower edge of the insertion slot 17a. Side guide projections 32b and 32c or rails on the left and right sides are formed to project from the receiving surface 32a for guiding the card-shaped storage medium 5 in the insertion and ejection by contacting lateral edges 52 of the card-shaped storage medium 5. An inclined end portion 36 at an outer end of the side guide projection 32c has a curved shape to spread transversely to the slide of the card-shaped storage medium 5. A tilted portion 38 at an innermost end of the receiving surface 32a has a tilted surface for smoothly receiving and guiding a proximal end of the card-shaped storage medium 5 during the ejection. Positioning portions (not shown) are formed with the outer panel 31 and the guide plate 32. In the course of the manufacture, the guide plate 32 is positioned on the outer panel 31 exactly by use of the positioning portions, and attached to the outer panel 31 by application of a double-sided adhesive tape.

A stopper portion 7d for the open position is formed on the front panel 7, contacts the regulating arm 31c to limit rotation when the cover 30 rotates to the open position, and positions the cover 30 in the open position. A stopper portion 7e for the closed position is formed on the front panel 7, contacts the regulating arm 31d to limit rotation when the cover 30 rotates to the closed position, and positions the cover 30 in the closed position.

A biasing spring plate 35 is secured to the inside of the front panel 7, contacts the regulating arm 31c constantly, and biases the cover 30 in directions toward the open and closed positions. The spring plate 35, when the cover 30 is shifted near to the open position, biases the cover 30 toward the open position, and when the cover 30 is shifted near to the closed position, biases the cover 30 toward the closed position.

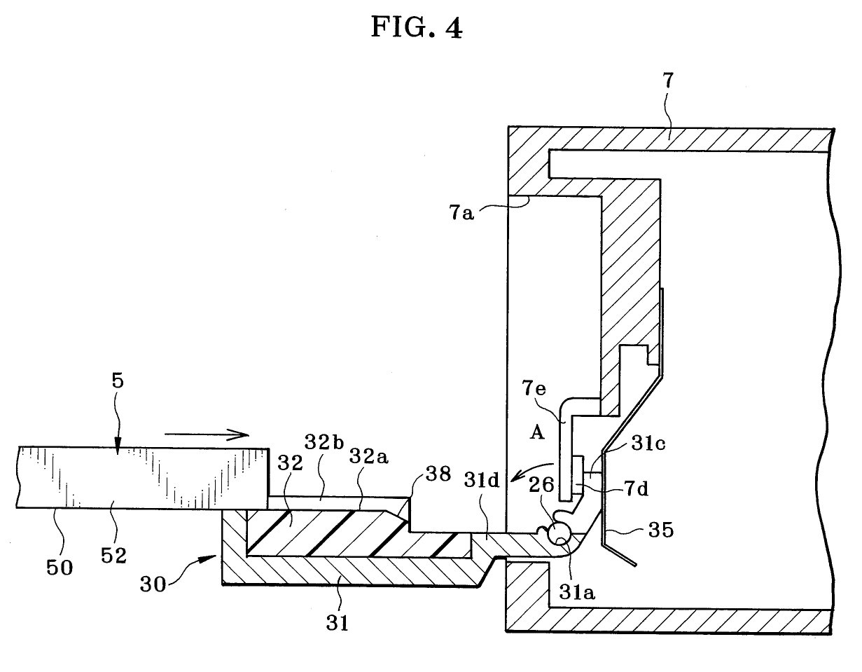

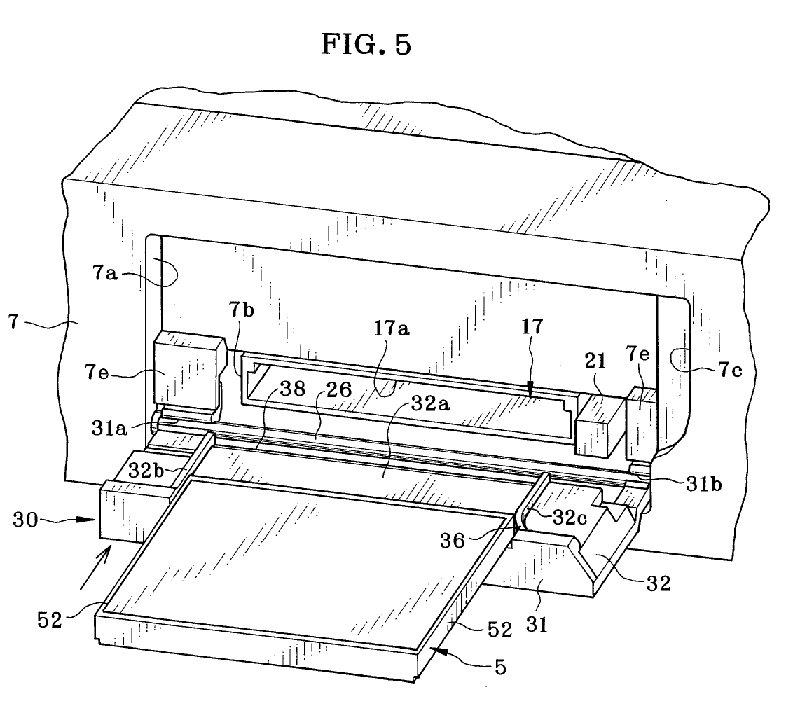

The operation of the data reproduction apparatus 2 is described now. To set the card-shaped storage medium 5, at first the cover 30 or door is rotated to the open position as illustrated in FIGS. 4 and 5. The cover 30 in the open position is biased by the spring plate 35 in the direction A of the contact of the regulating arm 31c with the stopper portion 7d. The cover 30 is kept set in the open position without incidental shift toward the closed position even upon occurrence of shock, vibration or the like.

When the card-shaped storage medium 5 is slid in the inward direction on the receiving surface 32a, the card-shaped storage medium 5 is guided by the side guide projections 32b and 32c laterally with the lateral edges 52, and becomes inserted in the insertion slot 17a. When the card-shaped storage medium 5 is pushed to the play position, the latch arm 23 is locked in a state of charging the ejection spring 22.

Then the cover 30 is rotated to the closed position in FIG. 3. The cover 30 is biased by the spring plate 35 in the direction B for contact of the regulating arm 31d with the stopper portion 7e. Then the cover 30 is set in the closed position without incidental shift toward the open position even upon occurrence of shock, vibration or the like.

A direction of the bias of the spring plate 35 to the cover 30 changes with respect to a changeover position defined between the open and closed positions. In a section from the open position to the changeover position, the cover 30 is biased toward the open position. In a section between the closed position and the changeover position, the cover 30 is biased toward the closed position. Therefore, the cover 30 rotating between the open and closed positions can be operated with suitable manual touch for good handlability. Also, the cover 30 can rotate stably without considerable play, because biased constantly by the spring plate 35.

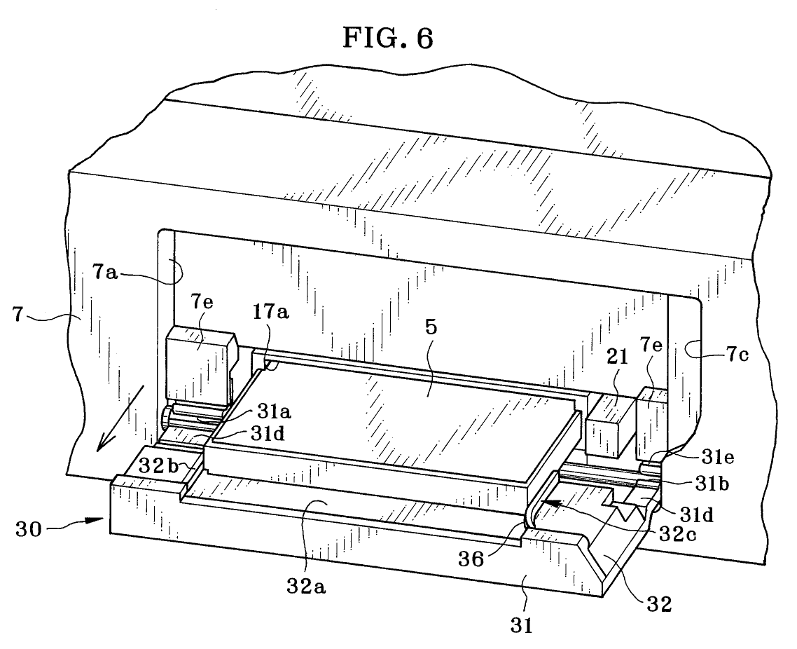

To unload the card-shaped storage medium 5, the cover 30 is rotated to the open position. The eject button 21 is depressed. In response to this, the latch arm 23 is unlocked. In FIG. 6, the card-shaped storage medium 5 is ejected by the bias of the ejection spring 22.

The card-shaped storage medium 5 slides in the outward direction while supported on the receiving surface 32a. The lateral edges 52 are guided by the side guide projections 32b and 32c during the slide. Then a user can pick up and remove the card-shaped storage medium 5 by moving the same in the outward direction.

Consequently, the card-shaped storage medium 5 can be inserted in the insertion slot 17a easily by sliding in the inward direction on the receiving surface 32a, because the receiving surface 32a of the guide plate 32 supports the lower surface 50 during the insertion.

The card-shaped storage medium 5 being ejected is supported by the receiving surface 32a, and therefore can be removed easily only by moving the card-shaped storage medium 5 in the outward direction on the receiving surface 32a.

The use of the side guide projections 32b and 32c of the guide plate 32 is effective in facilitating the insertion and ejection of the card-shaped storage medium 5, because its lateral edges 52 can be guided in the direction transverse to the slide.

Also, the cover 30 is constituted by the outer panel 31 and the guide plate 32. Even if aluminum or the like is used as material of the outer panel 31 having a relatively high friction of the surface, the guide plate 32 can be formed from a material having a relatively low friction of the surface in comparison with the outer panel 31. This is effective in smooth slide of the card-shaped storage medium 5 on the receiving surface 32a.

Also, the single spring plate 35 biases the cover 30 in the directions toward the open and closed positions. Thus, the manufacturing cost can be reduced by reducing the number of the parts in comparison with a double spring mechanism including a spring for opening and a spring for closing.

In the above embodiment, the data reproduction apparatus 2 has the cover according to the invention. However, a data reproduction apparatus of the invention may be other devices in which an insertion slot is formed and data is recorded to and/or played from a memory card set in the insertion slot, for example, a display device in which a reader/writer is incorporated, a media player, a card reader, and the like.

In the embodiment, the eject button 21 is depressed to eject the card-shaped storage medium 5. However, a mechanism of a push-push latch may be used, in which the card-shaped storage medium 5 in the play position may be further depressed in the inward direction and cause ejection of the card-shaped storage medium 5 in the outward direction.

Furthermore, the cover 30 may be constructed as one piece in which the outer panel 31 and the guide plate 32 are combined.

Also, elements other than the spring plate 35 may be used to bias the cover 30, for example, a tension coil spring, a compression coil spring, a torsion coil spring, and the like having resiliency or elasticity.

In the above embodiment, the card-shaped storage medium 5 is ejected by the bias of the ejection spring 22. However, a rotatable mechanism with an ejection lever may be used to press the card-shaped storage medium 5 outwards for ejection. To this end, the eject button 21 presses one end of the ejection lever for rotation. A second end of the ejection lever pushes out the card-shaped storage medium 5.

Furthermore, an ejection switch can be associated with the ejector without the structure of the eject button 21. The ejection switch is operable to generate a drive signal to drive the ejector. Also, the holder chamber 17 can lack an ejector. A user may pull out and remove the card-shaped storage medium 5 only by manual operation. For this structure, the holder chamber 17 can have a form for a finger easily to pick up an end or corner of the card-shaped storage medium 5.

In the above embodiment, the pivot shaft 26 is inserted in the pivot holes 31a and 31b. The pivot shaft 26 may be rotatable on the inner edges of the front opening 7b, or stationary thereon. The stationary pivot shaft 26 may be externally secured to the front opening 7b, or may be originally formed with the front opening 7b as a portion of the front panel 7. Also, various types of rotational support mechanisms other than this may be used for the cover 30 or door. For example, pivot pins are formed to project laterally from respectively side portions of the cover 30. Bearing sleeves are formed with inner edges of the front opening 7b, and receive the pivot pins in a rotatable manner.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. A data reproduction apparatus for reproducing data in a card-shaped storage medium, comprising:
an insertion slot, formed to open substantially horizontally, for insertion of said card-shaped storage medium to load;
an ejector for ejecting said card-shaped storage medium through said insertion slot; and
a cover, positioned outside said insertion slot, rotatable between open and closed positions, having a receiving surface, for extending outwards from a lower edge of said insertion slot when in said open position, to guide a lower surface of said card-shaped storage medium moving inwards or outwards through said insertion slot on said receiving surface, and for covering and closing said insertion slot when in said closed position.

2. A data reproduction apparatus as defined in claim 1, further comprising:
a holder chamber, having said insertion slot, for loading said card-shaped storage medium therein;
a case for containing said holder chamber with said insertion slot positioned to appear externally when said cover is in said open position; and
a rotational support mechanism for supporting said cover in a rotatable manner.

3. A data reproduction apparatus as defined in claim 2, wherein said cover includes:
a guide plate having said receiving surface on an inner side; and
an outer panel secured to an outer side of said guide plate.

4. A data reproduction apparatus as defined in claim 3, wherein said guide plate is formed from resin, and said outer panel is formed from metal.

5. A data reproduction apparatus as defined in claim 2, wherein said cover includes first and second side guide projections, positioned on said receiving surface, for contacting lateral edges of said card-shaped storage medium to guide.

6. A data reproduction apparatus as defined in claim 5, further comprising an inclined end portion, formed at an outer end of at least one of said first and second side guide projections, inclined to spread with reference to a sliding direction of said card-shaped storage medium, for guiding a lateral edge of said card-shaped storage medium in insertion.

7. A data reproduction apparatus as defined in claim 5, wherein said rotational support mechanism includes:
a pivot shaft disposed on said case to extend substantially horizontally; and
a pivot hole, formed through a lower portion of said cover, for receiving insertion of said pivot shaft.

8. A data reproduction apparatus as defined in claim 2, further comprising:
a first stopper portion for positioning said cover in said open position;
a second stopper portion for positioning said cover in said closed position; and
a biasing mechanism for biasing said cover toward said first stopper portion upon rotation toward said open position, and for biasing said cover toward said second stopper portion upon rotation toward said closed position.

9. A data reproduction apparatus as defined in claim 8, wherein said biasing mechanism includes a spring plate;
further comprising a regulating arm, disposed to project from said cover, positioned inside said case, and pressed by said spring plate in said open and closed positions.

10. A data reproduction apparatus as defined in claim 9, wherein said spring plate includes a base portion, a middle portion and an end portion;
said base portion is secured to said case;
said middle portion extends from said base portion, and presses said regulating arm in a first rotational direction when said cover is in said open position;
said end portion extends from said middle portion, and presses said regulating arm in a second rotational direction when said cover is in said closed position.

11. A data reproduction apparatus as defined in claim 2, wherein said cover further includes a tilted portion, tilted downwards from said receiving surface toward said insertion slot, for guiding an edge between a proximal end surface of said card-shaped storage medium and said lower surface in ejection.
